(19) United States
(12) Patent Application Publication
(10) Pub. No.: US 2025/0350904 A1
(43) Pub. Date: Nov. 13, 2025

(54) SYSTEM AND METHOD FOR DETERMINING THE LOCALIZATION OF AN OBJECT BY COMPARING SENSING DATA

(71) Applicant: Wiliot, Ltd., Caesarea (IL)

(72) Inventors: Ohad SILBERT, Sunnyvale, CA (US); Evi KOPELOWITZ, Petah Tikva (IL); Yitzhak PELEG, Netanya (IL)

(73) Assignee: Wiliot, Ltd., Caesarea (IL)

(21) Appl. No.: 19/203,675

(22) Filed: May 9, 2025

Related U.S. Application Data
(60) Provisional application No. 63/645,533, filed on May 10, 2024.

(51) Int. Cl. H04W 4/02; G16Y 20/10

(52) U.S. Cl. CPC H04W 4/025; G16Y 20/10; H04W 4/023

(57) ABSTRACT

A system and method of detecting the location of objects attached to IoT tags are provided. The method includes receiving data packets from a gateway, wherein the received data packets include sensing data derived from signals transmitted by an IoT tag having an unknown location; comparing the sensing data of the unknown IoT tag to sensing data of a cluster of IoT tags having a known established location, wherein the comparison applies at least one statistical model; associating the unknown IoT tag with the cluster of IoT tags having the known established location based on the comparison; and determining a location of the unknown IoT tag based on the associated cluster.

### CROSS-REFERENCE OF RELATED APPLICATIONS

This application claims the benefit of U.S. Provisional Application No. 63/645,533, filed on May 10, 2024, the contents of which are hereby incorporated by reference.

### TECHNICAL FIELD

The present disclosure relates generally to a system and method for determining the location of an object, and more specifically to determining the localization of objects based on wireless Internet of Things (IoT) tags and sensing data.

### BACKGROUND

The Internet of Things (IoT) is the inter-networking of physical devices, vehicles, buildings, and other items embedded with electronics, software, sensors, actuators, and network connectivity that enable these objects to collect and exchange data. IoT is expected to offer advanced connectivity of devices, systems, and services that go beyond Machine-to-Machine (M2M) communications and covers a variety of protocols, domains, and applications.

IoT can be encapsulated in a wide variety of devices, such as heart monitoring implants, biochip transponders on farm animals, automobiles with built-in sensors, automation of lighting, Heating, and Ventilation Air Conditioning (HVAC) systems, and appliances such as washer/dryers, robotic vacuums, air purifiers, ovens or refrigerators/freezers that use Wi-Fi for remote monitoring. Typically, IoT devices encapsulate wireless sensors or a network of such sensors.

Most IoT devices are wireless devices that collect data and transmit such data to a central controller. There are a few requirements to be met to allow widespread deployment of IoT devices. Such as reliable communication links, low energy consumption, and low maintenance costs.

IoT devices often rely on battery power, which can be a limiting factor, especially for tags or sensors deployed in remote or inaccessible locations. Balancing the need for accurate localization with power efficiency is crucial to extend the lifespan of battery-powered IoT devices. Developing technologies that are utilized to address these issues include energy-efficient localization techniques and low-power communication protocols for IoT devices such as Bluetooth,® Low Energy (BLE), and Long Range (LoRa®) platforms.

IoT tags do not have the means to provide their current location as they are not equipped with, for example, a built-in global positioning system (GPS) or other sophisticated localization hardware. Integrating a GPS or other sophisticated localization hardware into IoT tags can significantly increase their cost and also require high power consumption. Furthermore, IoT tags especially those used for tracking small items or embedded in compact devices, may have stringent size and form factor requirements. Integrating a GPS, or localization hardware while maintaining a small form factor can be challenging and may not always be feasible.

It would be, therefore, advantageous to provide a solution that overcomes the above-noted challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting a location of objects, attached with an IoT tag. The method comprises: receiving data packets from a gateway, wherein the received data packets include sensing data derived from signals transmitted by an IoT tag having an unknown location; comparing the sensing data of the unknown IoT tag to sensing data of a cluster of IoT tags having a known established location, wherein the comparison applies at least one statistical model; associating the unknown IoT tag with the cluster of IoT tags having the known established location based on the comparison; and determining a location of the unknown IoT tag based on the associated cluster.

Certain embodiments disclosed herein also include a non-transitory computer readable medium having stored thereon causing a processing circuitry to execute a process, the process comprising: receiving data packets from a gateway, wherein the received data packets include sensing data derived from signals transmitted by an IoT tag having an unknown location; comparing the sensing data of the unknown IoT tag to sensing data of a cluster of IoT tags having a known established location, wherein the comparison applies at least one statistical model; associating the unknown IoT tag with the cluster of IoT tags having the known established location based on the comparison; and determining a location of the unknown IoT tag based on the associated cluster.

Certain embodiments disclosed herein also include a system for detecting a location of objects, attached with an IoT tag. The system comprises: a processing circuitry; and a memory, the memory containing instructions that, when executed by the processing circuitry, configure the system to: receive data packets from a gateway, wherein the received data packets include sensing data derived from signals transmitted by an IoT tag having an unknown location; compare the sensing data of the unknown IoT tag to sensing data of a cluster of IoT tags having a known established location, wherein the comparison applies at least one statistical model; associate the unknown IoT tag with the cluster of IoT tags having the known established location based on the comparison; and determine a location of the unknown IoT tag based on the associated cluster.

Certain embodiments disclosed herein include the method, non-transitory computer readable medium, or system noted above, further including or being configured to perform the following steps: determining a distance between the sensing data of the unknown IoT tag and the sensing data of the cluster of IoT tags having the known established location.

Certain embodiments disclosed herein include the method, non-transitory computer readable medium, or system noted above, further including or being configured to perform the following steps: determining the cluster of IoT tags having the known established location as a match based on a proximity of the determined distance.

Certain embodiments disclosed herein include the method, non-transitory computer readable medium, or system noted above, wherein the statistical model includes any one of: a machine learning model, a clustering algorithm, a Gaussian Mixer Model (GMM), a Z-test, a T-test, a Kolmogorov-Smirnov test, and maximum likelihood estimation.

Certain embodiments disclosed herein include the method, non-transitory computer readable medium, or system noted above, further including or being configured to perform the following steps: including the unknown IoT tag in the associated cluster of IoT tags.

Certain embodiments disclosed herein include the method, non-transitory computer readable medium, or system noted above, wherein the sensing data includes any one of: temperature, light, and humidity.

Certain embodiments disclosed herein include the method, non-transitory computer readable medium, or system noted above, wherein the sensing data of the unknown IoT tag does not include the known established location.

Certain embodiments disclosed herein include the method, non-transitory computer readable medium, or system noted above, further including or being configured to perform the following steps: applying a machine learning model to the comparison and sensing signals.

Certain embodiments disclosed herein include the method, non-transitory computer readable medium, or system noted above, wherein the sensing signals are at least one of: a frequency word, a packet rate, a received signal strength indicator (RSSI), a gateway identifier (ID), a bridge identifier (ID), and an IoT tag identifier (ID).

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a localization system utilized for associating an object to an established location, described in the disclosed embodiments.

FIG. 2 is a flowchart for a method of associating an IoT tag having an unknown location to an established location, according to an embodiment.

FIG. 3 is an example of an association of an unknown IoT tag to an established location from multiple clusters of IoT tags, according to an embodiment.

FIG. 4 is a schematic diagram of a server, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining the localization of an object. The method is performed by a system deployed, for example, in a cloud computing system or a server. The system is configured to process sensing signals received from an Internet of Things (IoT) tag attached to an object. The IoT tag transmits sensing signals to a local gateway using a low-power communication protocol. The gateway relays the sensing signals to the server over, for example, the Internet.

As will be discussed in detail below, the system is configured to analyze the sensing signals of an IoT tag attached to an object and compare the sensing signals to a distribution of sensing signals from various clusters of IoT tags in order to associate an established location with the object.

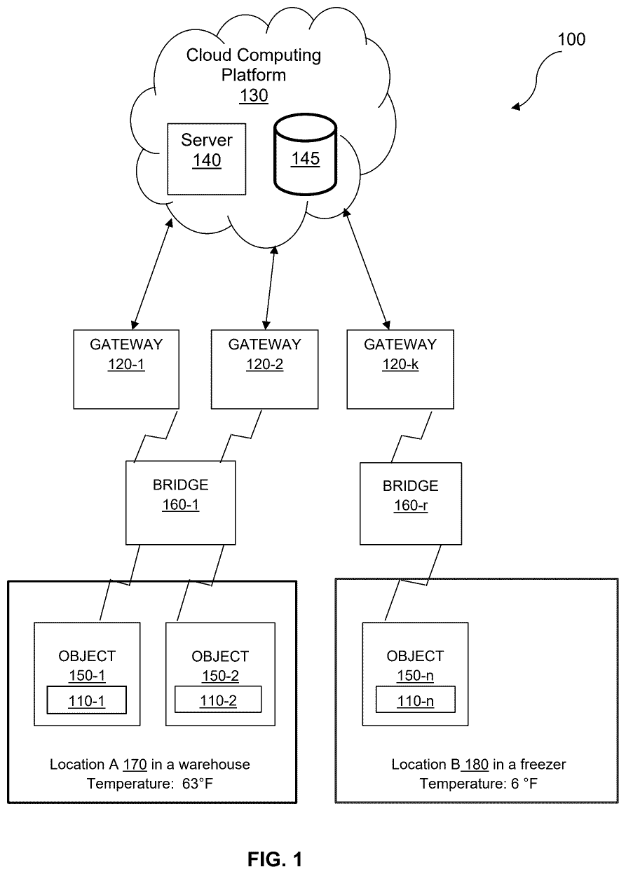

FIG. 1 is an example schematic diagram of an object localization system 100 utilized to describe the various embodiments. The system 100 includes a plurality of Internet of Things (IoT) tags 110-1 through 110-n (collectively referred to as an IoT tag 110 or IoT tags 110, wherein n is an integer greater than 1), a single gateway 120-1 or a plurality of gateways 120-1 through 120-k (collectively referred to a gateway 120 or a plurality of gateways 120, wherein k is an integer greater than 1), a single bridge 160-1 or a plurality of bridges 160-1 through 160-r (collectively referred to a bridge 160 or a plurality or bridges 160, wherein r is an integer greater than 1), and a cloud computing platform 130. In an embodiment, an IoT tag 110 is attached to an object 150-1 or a plurality of objects 150-1 through 150-n (collectively referred to as an object 150, wherein n is an integer greater than 1). In an embodiment, the object localization system 100 includes at least one server 140 that may be deployed in the cloud-based platform 130.

The server 140 may be realized as a physical machine, a virtual machine, or a combination thereof. The cloud computing platform 130 may be a public cloud, a private cloud, or a hybrid cloud. In an embodiment, database 145 is also deployed in the cloud-based platform 130 and may be connected to the server 140. In certain embodiments, the database 145 stores the locations determined by the server 140, identifiers (IDs) of IoT tags 110, and other sensing signals.

In an embodiment, the IoT tag 110 is a battery-free IoT tag that utilizes an antenna and a harvester for energy harvesting as well as wireless communication. In some embodiments, multiple antennas may be utilized to harvest energy at multiple frequency bands. Other embodiments, the IoT tag may include one or more antennas for energy harvesting and an antenna to receive/transmit wireless signals at the BLE frequency band. Also, communication among the IoT tags 110, the bridges 160, and the gateways 120 may be performed using a low-energy communication protocol. In an example embodiment, the low-energy communication protocol includes a Bluetooth Low Energy (BLE) protocol, which are short-wavelength radio waves operating at a range of about 2.40 to 2.485 MHz, and commonly used among portable wireless devices. It should be appreciated that the battery-free IoT tags 110 have a small form factor.

The cloud computing platform 130 may include a public cloud, a private cloud, a hybrid cloud, or a combination thereof. The communication between the cloud computing platform 130 and the gateway 120 is over, for example, the Internet. A public cloud is owned and operated by a third-party service provider that delivers computing resources for use over the internet, whereas a private cloud is cloud computing resources that are exclusively used by a single business or an organization. A hybrid cloud combines the public cloud and the private cloud that allows data and application sharing between both types of computing resources. Some examples of a cloud computing platform 130 may include, without limitation, Amazon® Web Services (AWS), Microsoft® Azure, Google® Cloud Platform (GCP), and the like, which offer shared infrastructure managed by the cloud providers, providing scalability, flexibility, and reduced infrastructure management.

In an embodiment, the gateway 120 is an edge computing device configured to receive and aggregate signals from the IoT tags 110. In certain embodiments, the gateway 120 is configured to encapsulate the signals together with additional data in data packets and transmit the data packets to the cloud computing platform 130 to be processed by the server 140. The gateway 120 acts as the central controller for the transmitting IoT tag 110 signals to the server 140 at the cloud computing platform 130. The communication between the gateway 120 and the cloud computing platform 130 may be over the Internet or a network. In an embodiment, the gateway 120 receives IoT tag 110 signals by the bridge 160. In a further embodiment, the gateway 120 receives IoT tag 110 signals directly.

In an embodiment, the bridge 160 is configured to power the IoT tags 110 and enable communication between the IoT tags 110 and the gateways 120. Each location of the IoT tags may not necessarily be separated by each bridge 160. In an example embodiment, a specific bridge 160 is not tied to a designated location and may be used in various locations as needed. In another example embodiment, multiple bridges 160 may be used in a single location to receive sensing signals from IoT tags 110 in the signal range. The powering of the IoT tags 110 includes the transmission of radio frequency (RF) signals so that their energy may be harvested by the IoT tags 110. The charged up IoT tag 110 may transmit sensing signals upon receiving the power-up signals.

The bridge 160 may be any edge computing device, such as, but not limited to, a laptop, a tablet computer, a smartphone, a personal computer (PC), and the like. In some embodiments, the bridge 160 is a portable device that may be wearable, handheld, and the like. In an example embodiment, the bridge 160 is a standalone device. In an embodiment, each bridge 160 may be assigned a bridge identifier (ID), a group identifier (ID), and the like, and any combination thereof. It should be noted that the bridge 160 may be deployed and utilized in proximity to the IoT tag 110 to reduce latency issues between the IoT tags 110 and the bridge 160.

In certain embodiments, the IoT tag 110 may be attached, glued, or placed on an object 150 such as, but not limited to, a cooler, freezer, fridge, compartment, container, shelf, box, and the like. The IoT tags 110 sense a particular radio frequency (RF) or ambient activity relative to, but not limited to, the changes in measurements of temperature, humidity, and ambient light of the object or imposed on the object. The sensing is performed at a certain location. Thus, the sensing signals, including, but not limited to, the temperature, humidity, ambient light, and the like, correlate to the location of the object 150. In addition, the sensing signals may include a frequency words, a received signal strength indicator (RSSI), a digitally controlled oscillator (DCO) signals, a packet rate, and the like, and any combination thereof. Such sensing signals may be caused by an interference to the ambient RF field with a change in the calibration frequency of the IoT tag 110.

In an embodiment, the IoT tags 110 transmit the sensing signals to the gateway 120. In a further embodiment, IoT tag signal may be transmitted via the bridge 160 in proximity to the IoT tag 110 and thereafter to the gateway 120. In an embodiment, the gateway 120 is configured to aggregate the signals generated from the IoT tags 110 based on the IoT tag's identification (e.g., the IoT tag ID).

In certain embodiments, the gateway 120 is further configured to relay the sensing signal information to the server 140. The server 140 is configured to receive the aggregated signals from the gateway 120 as data packets. In addition to the sensing signals, the data packet for an IoT Tag 110 may include additional information (or metadata) such as, but not limited to, an identifier (ID) of an IoT tag 110, an identifier (ID) of the gateway 120, an identifier (ID) of the bridge 160, time stamp, and the like, and any combination thereof. The ID is unique to each IoT tag 110, gateway 120, and the bridge 160. In some embodiments, the gateway 120 may relay signals intermittently, periodically, on demand, or any combination thereof, to the server 140.

In an embodiment, the server 140 is configured to compare the sensing signals of an IoT tag 110 having an unknown location (hereinafter “unknown IoT tag”) to one or more clusters of IoT tags having a known location. An unknown IoT tag is a tag that is not associated with a cluster. A cluster is a group of one or more IoT tags 110 with an established location based sensing signals generated from the IoT tag 110 and/or any external data. In an embodiment, the comparison may be performed by applying at least one algorithm such as, but not limited to, one or more statistical distance measures, a machine learning algorithm, and the like, and any combination thereof.

In an embodiment, an unknown IoT tag, is associated with an established cluster based on the sensing signals of the known IoT tag. Further, a known location may be prior established by the disclosed embodiments or set by a user through a portal or user terminal (not shown). In the example diagram 100, object 150-1 attached with IoT tag 110-1 and object 150-2 attached with IoT tag 110-2 are both in Location A 170 with a temperature of 63 degrees Fahrenheit. In a further example, object 150-n attached to IoT Tag 110-n are in Location B 180 with a temperature of 6 degrees Fahrenheit.

In some example embodiments, a cluster of one or more IoT tags 110 may be placed in a specifically known location as reference IoT tags 110 and may be utilized to determine a location of the unknown IoT tag. As an example, a location may be an area or zone in a warehouse with a predefined square footage. In another example, a location may be a room in the warehouse, for example, a freezer room, a storage space, and more.

It should be noted that the connections between the objects 150, bridges 160, and the gateway 120 are shown as illustrations and do not limit the scope of the disclosed embodiments. For example, the IoT tag 110-1 on object 150-1 may transmit signals to one or more bridges 160, bridge 160-1 may receive signals from IoT tags 110 at different locations if the IoT tags 110 are charged and within communication distance from the bridge 160-1, and the like. In some implementations, the IoT tag 110 may transmit its data packets to a bridge 160 and/or gateway 120.

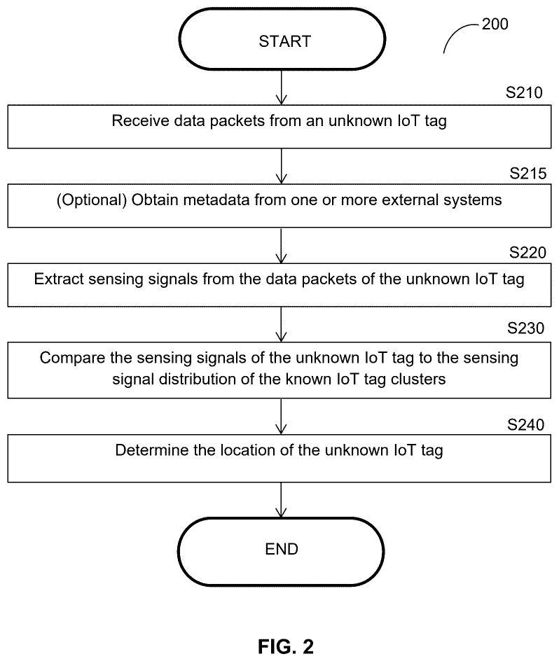

FIG. 2 is an example flowchart 200 of a method for object localization based on an IoT tag 110, according to an embodiment. The method described herein is performed by the server 140, FIG. 1.

The method is described with respect to a single IoT tag 110, FIG. 1 for simplicity; however, the method may be performed simultaneously for a plurality of IoT tags at various locations without departing the scope of the disclosed embodiments. In addition, the server 140 is configured to process data packets received via one or more bridges 160 and/or gateways 120.

At S210, data packets of an unknown IoT tag are received. In an embodiment, the data packets include the aggregation of sensing signals and an identification (ID) of the unknown IoT tag (e.g., the IoT tag 110, FIG. 1). In an embodiment, the identification (ID) of an IoT tag may be a serial number or any other identifier consisting of, for example, but not limited to, letters, numerals, and the like, and any combination thereof. The data packets may include additional information such as, but not limited to, a bridge ID, a gateway ID, a time stamp, and the like, and any combination thereof. The aggregation and transmission of data packets are performed by the gateway (e.g., the gateway 120, FIG. 1) and relayed to the server.

In an embodiment, a bridge (e.g., the bridge 160, FIG. 1) sends power-up signals to charge the battery-less IoT tag to transmit sensing signals to the bridge and/or gateway. It should be appreciated that the battery-less IoT tag is relatively small and cost efficient. Moreover, the low-energy communication protocol employed enables effective communication using the changed IoT tag.

At S215, optionally, metadata are obtained from one or more external systems. In an embodiment, metadata includes, for example, but not limited to, the weather information, geo-location of a facility where IoT tags are deployed, the time of the day the signals are transmitted and aggregated by the gateway, the temperature at the facility, and the humidity at the facility of the IoT tag, and so on. The external system may include a Heating, Ventilation, and Air Conditioning (HVAC) system, a weather service system, a geo-location service system, and the like. It should be noted that the geo-location information relates to the facility and not the IoT tags inside the facility. For example, the geo-location information may be the address of a warehouse, and an unknown IoT tag may be attached to a box of oranges in the warehouse.

The metadata may be used to determine the location of the unknown IoT tag. In an embodiment, S215, and hence the metadata is optional.

At S220, sensing signals are extracted from the received data packets. As noted above, sensing signals describe environmental conditions such as, but not limited to, temperature, humidity, ambient lighting, and the like, and any combination thereof. In an embodiment, the extracted sensing signals are processed, for example, to normalize the information in the sensing signals, to convert the temperature to Celsius, to reduce noise, and the like. In a further embodiment, sensing signals such as, but not limited to, a frequency word, an RSSI, a DCO signal, a packet rate, and the like, and any combination thereof that provide relevant information on the IoT tag may be extracted from the received data packets.

At S230, the sensing signals from the unknown IoT tag are compared to the sensing signal distribution of known IoT tag clusters to determine which cluster to associate the unknown IoT tag with. For example, sensing signals such as the humidity measurement of the unknown IoT tag are compared to the humidity distribution based on the sensing signals of the known IoT tag cluster. The known IoT tag cluster is a group of one or more IoT tags with a known location. The sensing signals for the known IoT tag cluster may be collected and stored at the cloud computing platform (e.g., the cloud computing platform 130, FIG. 1).

In an embodiment, a distance between the sensing signals of the unknown IoT tag and those of the known IoT tag cluster is determined in order to identify the cluster in proximal distance from the sensing signals of the unknown IoT tag. In a further embodiment, a score (or probability) is determined for each known IoT tag cluster based on the sensing signals comparison with the unknown IoT tag, for example, the distance. As an example, a high score may indicate relatively close distance, and similar measurements in sensing signals, of the unknown IoT tag to a cluster of known IoT tags. In the same example, a low score may indicate a relatively far distance, and a large deviation in sensing signals, of the unknown IoT tag from the cluster of known IoT tags. As noted herein, the distance is a statistical distance of signals of unknown and known IoT tags.

In some embodiments, the comparison may utilize the metadata collected at S215. For example, the geo-location may be employed to associate the unknown IoT tag to cluster A that is known to be at the same warehouse location rather than cluster B that is known to be at a different warehouse location in another address.

In an embodiment, 230 includes applying a Kolmogorov-Smirnov (KS) test. The K-S test compares a sensing signal (or its value) with a reference probability distribution of each cluster. That is, the K-S test assesses how well (i.e., closely) a value of a sensing signal (i.e., sample) matches a specified distribution of sensing signals in a cluster (i.e., a reference distribution). The test calculates the K-S statistic, which is the maximum difference between the empirical cumulative distribution function (ECDF) of the sample and the cumulative distribution function (CDF) of the reference distribution. A cluster with the minimum K-S statistic (i.e., proximal distance) among all comparisons, between clusters to sensing signals, is determined as the cluster with which to associate the unknown IoT tag. In an embodiment, the metadata may be used to determine the confidence of the comparison.

It should be noted that the comparison at S230 to identify the cluster for the unknown IoT tag may be performed by applying other algorithms, such as, but not limited to, a machine learning model, a clustering algorithm, a gaussian mixer model (GMM), a T-test, a Z-test, maximum likelihood estimation (MLE), other statistical models, and the like.

A machine learning model is a program that is used to analyze and make predictions for a given data set. A machine learning model is built by a machine learning algorithm that, in some cases for supervised learning, takes a known set of input data and a known set of responses or output data and trains the machine learning model to generate reasonable predictions for the response to the new data. In some other cases, such as unsupervised learning, the machine learning model may be trained using unlabeled datasets without known responses to find patterns. A clustering algorithm groups data points of common characteristics into clusters. The GMM is a machine learning method used to determine the probability of each data point belonging to a particular cluster. The MLE is a statistical method used to estimate the parameters of a probability distribution that describes a given data set.

The unknown IoT tag generates signals regarding environmental conditions or measurements in the vicinity of an object the IoT tag is attached to. However, the unknown IoT tag does not directly provide its location or any association with a known location. To associate a known location with the unknown IoT tag, a comparison of sensing signals pertaining to environmental conditions of the unknown IoT tag are compared to such conditions of known IoT tags in specific clusters. The sensing signals may include information on temperature, humidity, ambient lighting, and the like.

For example, an unknown IoT tag has a sensing signal indicating 62 degrees Fahrenheit, known IoT tags in location A have an average temperature distribution of 60-70 degrees Fahrenheit, and known IoT tags in location B have an average temperature distribution of 4-14 degrees Fahrenheit. According to this example, the unknown IoT tag is associated with the known IoT tags in location A as its temperature falls within the temperature range of the known IoT tags associated with location A.

At S240, a location of the unknown IoT tag is determined based on the scores of each cluster. Each cluster is assigned a score based on the comparison of the unknown IoT tag sensing signals and the distribution of the sensing signals of each location. The unknown IoT tag is associated with a probability of belonging at a location of each known cluster location based on the score. The locations probabilities, together with the computed scores for each cluster location may be reported as an event on a user portal (not shown) and/or saved in a database (e.g., database 145). In an embodiment, S240 may further include adding the IoT tag to its associated location. In a further embodiment, the unknown IoT tag is added to the matched cluster of known IoT tags, which are identified to be at the same location.

In an embodiment, at least one of the algorithms, such as the machine learning algorithm, is applied to the determined distance (or score), extracted sensing signals such as, but not limited to, the frequency word, RSSI, packet rate, IDs (e.g., bridge, gateway, IoT tag, etc.), and the like to determine the location of the unknown IoT tag. In addition to the environmental measurements of, for example, but not limited to, temperature, humidity, ambient light, and the like, such relevant additional data enable accurate matching of the unknown IoT tag to at least one known location. It should be noted that the method disclosed herein provides an effective method to determine and track locations of an object using a low power, battery-less IoT tag. The sensing signals are utilized for the localization without adding additional burden of data collection or transmittance for locational information thereby conserving power at the IoT tag and other components in communication (e.g., the bridge, the gateway, and the server).

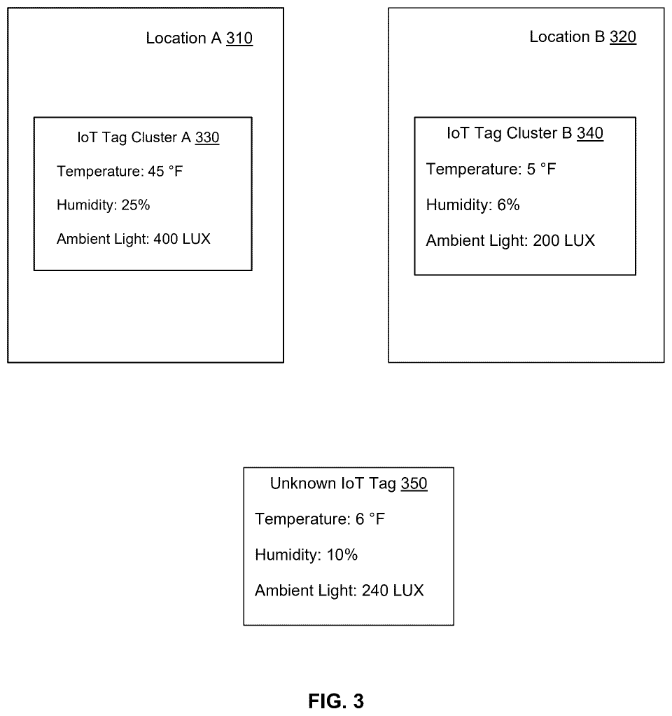

FIG. 3. are example IoT tags showing the association of an unknown IoT Tag to a cluster of IoT tags of a known location according to an embodiment. The example includes IoT tag clusters A 330 and B 340, each located at specific locations, location A 310 and location B 320, respectively. Each IoT tag cluster 330, 340 is associated with a distribution of sensing signals describing the environmental conditions of its associated location 310, 320. For example, IoT tag cluster A 330 is associated with Location A 310. The IoT tag cluster A has sensing signals showing an average distribution of a temperature of 45 degrees Fahrenheit, humidity of 25 percent, and ambient light of 400 lumen per square meter (LUX). The IoT tag cluster B, 340, which is associated with Location B 320, has an average distribution of a temperature of 5 degrees Fahrenheit, humidity of 6 percent, and ambient light of 200 (LUX).

An unknown IoT tag 350 and its sensing signals are detected by a server (e.g., the server 140, FIG. 1) based on the received data packets. However, the data packet does not include a location for the unknown IoT tag 350. The server extracts the sensing signals from the data packets of the unknown IoT tag and utilize such data to associate the IoT tag with an established cluster such as the IoT tag cluster A 330 and/or the IoT tag cluster B 340. The server extracts any given measurements, for example, but not limited to, the temperature, humidity, and ambient light of the sensing signals and compares such measurements to distributions of sensing signals of the IoT tag clusters 330 and 340. As an example, the sensing measurements of the unknown IoT Tag 350 are determined to have an average temperature of 6 degrees Fahrenheit, a humidity of 10 percent, and an ambient light measurement of 240 (LUX). In an embodiment, based on that comparison, the server associates a cluster of either Location A 310 or Location B 320 to the unknown IoT tag 350.

Next, the server 140 is configured to compare these environmental measurements with the distributions of sensing signals of IoT tag cluster A 330 and IoT tag cluster B 340. In an embodiment, the comparison is completed using a statistical model, such as a machine learning model, a clustering algorithm, a Gaussian Mixture Model (GMM), a statistical test such as a Z-test, a T-test, a Kolmogorov-Smirnov test, or a maximum likelihood estimation. In an embodiment, a distance between the measurements is determined for the clusters, cluster A and cluster B, with respect to the unknown IoT tag 350. For example, in an embodiment, the machine learning model will perform the comparison and determine that the probability (or a score) of unknown IoT Tag 350 belonging to Location B 320 is higher since the sensing signals of the unknown IoT Tag 350 are closer to the sensing signals distribution of the IoT Tag cluster B 340. Thus, the location of the unknown IoT Tag 350 is determined to be Location B 320 since the probability is higher. In an embodiment, other sensing signals such as, but not limited to, packet rate, RSSI, bridge ID, and the like, are also employed to determine the location of the unknown IoT tag 350.

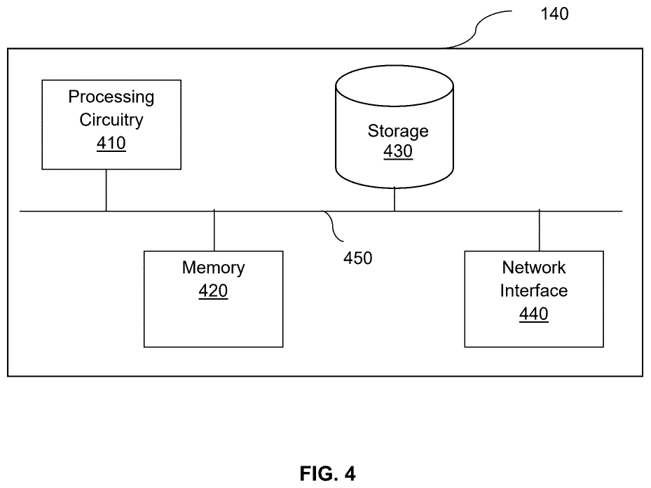

FIG. 4 is an example schematic diagram of a server 140 according to an embodiment. The server 140 includes a processing circuitry 410 coupled to a memory 420, a storage 430, and a network interface 440. In an embodiment, the components of the server 140 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the server 140 to communicate with, for example, the gateway 120 over, for example, the Internet.

It should be understood that the embodiments described herein are not limited to the specific architecture illustrated in FIG. 4, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer-readable medium consisting of parts or of certain devices and/or a combination of devices. The application program may be uploaded to and executed by a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method of detecting a location of objects, attached with an IoT tag, comprising:
receiving data packets from a gateway, wherein the received data packets include sensing data derived from signals transmitted by an IoT tag having an unknown location;
comparing the sensing data of the unknown IoT tag to sensing data of a cluster of IoT tags having a known established location, wherein the comparison applies at least one statistical model;
associating the unknown IoT tag with the cluster of IoT tags having the known established location based on the comparison; and
determining a location of the unknown IoT tag based on the associated cluster.

2. The method of claim 1, wherein comparing further comprises:
determining a distance between the sensing data of the unknown IoT tag and the sensing data of the cluster of IoT tags having the known established location.

3. The method of claim 2, further comprising:
determining the cluster of IoT tags having the known established location as a match based on a proximity of the determined distance.

4. The method of claim 1, wherein the statistical model includes any one of: a machine learning model, a clustering algorithm, a Gaussian Mixer Model (GMM), a Z-test, a T-test, a Kolmogorov-Smirnov test, and maximum likelihood estimation.

5. The method of claim 1, further comprising:
including the unknown IoT tag in the associated cluster of IoT tags.

6. The method of claim 1, wherein the sensing data includes any one of: temperature, light, and humidity.

7. The method of claim 1, wherein the sensing data of the unknown IoT tag does not include the known established location.

8. The method of claim 1, further comprising:
applying a machine learning model to the comparison and sensing signals.

9. The method of claim 8, wherein the sensing signals are at least one of: a frequency word, a packet rate, a received signal strength indicator (RSSI), a gateway identifier (ID), a bridge identifier (ID), and an IoT tag identifier (ID).

10. A non-transitory computer readable medium having stored thereon instructions for causing a processing circuitry to execute a process, the process comprising:
receiving data packets from a gateway, wherein the received data packets include sensing data derived from signals transmitted by an IoT tag having an unknown location;
comparing the sensing data of the unknown IoT tag to sensing data of a cluster of IoT tags having a known established location, wherein the comparison applies at least one statistical model;
associating the unknown IoT tag with the cluster of IoT tags having the known established location based on the comparison; and
determining a location of the unknown IoT tag based on the associated cluster.

11. A system for detecting a location of objects, attached with an IoT tag, comprising:
a processing circuitry; and
a memory, the memory containing instructions that, when executed by the processing circuitry, configure the system to:
receive data packets from a gateway, wherein the received data packets include sensing data derived from signals transmitted by an IoT tag having an unknown location;
compare the sensing data of the unknown IoT tag to sensing data of a cluster of IoT tags having a known established location, wherein the comparison applies at least one statistical model;
associate the unknown IoT tag with the cluster of IoT tags having the known established location based on the comparison; and
determine a location of the unknown IoT tag based on the associated cluster.

12. The system of claim 11, wherein the system is further configured to:
determine a distance between the sensing data of the unknown IoT tag and the sensing data of the cluster of IoT tags having the known established location.

13. The system of claim 12, wherein the system is further configured to:
determine the cluster of IoT tags having the known established location as a match based on a proximity of the determined distance.

14. The system of claim 11, wherein the statistical model includes any one of: a machine learning model, a clustering algorithm, a Gaussian Mixer Model (GMM), a Z-test, a T-test, a Kolmogorov-Smirnov test, and maximum likelihood estimation.

15. The system of claim 11, wherein the system is further configured to:
include the unknown IoT tag in the associated cluster of IoT tags.

16. The system of claim 11, wherein the sensing data includes any one of:
temperature, light, and humidity.

17. The system of claim 11, wherein the sensing data of the unknown IoT tag does not include the known established location.

18. The system of claim 11, wherein the system is further configured to:
apply a machine learning model to the comparison and sensing signals.

19. The system of claim 18, wherein the sensing signals are at least one of: a frequency word, a packet rate, a received signal strength indicator (RSSI), a gateway identifier (ID), a bridge identifier (ID), and an IoT tag identifier (ID).
